(19) United States
(12) Patent Application Publication
(10) Pub. No.: US 2026/0275902 A1
(43) Pub. Date: Sep. 17, 2026

(54) ENGINE BRAKING IN A SPLIT-CYCLE ENGINE

(71) Applicant: FPT INDUSTRIAL S.P.A., TORINO (IT)

(72) Inventors: Andrew Atkins, TORINO (IT); Nick Owen, TORINO (IT); Colin Bennett, TORINO (IT); Fabrizio Treccarichi, TORINO (IT)

(73) Assignee: FPT INDUSTRIAL S.P.A., TORINO (IT)

(21) Appl. No.: 19/683,367

(22) Filed: May 20, 2026

Related U.S. Application Data
(63) Continuation of application No. 18/689,361, filed on Sep. 6, 2022.

(30) Foreign Application Priority Data
Sep. 6, 2021 (GB) 2112643.8

(51) Int. Cl. F02B 33/22; F02B 17/00; F02B 37/18

(52) U.S. Cl. CPC F02B 33/22; F02B 17/005; F02B 37/18

(57) ABSTRACT

A split cycle internal combustion engine includes a compression cylinder accommodating a compression piston configured to provide compressed working fluid; and a combustion cylinder accommodating a combustion piston. The combustion cylinder is coupled to the compression cylinder to receive compressed working fluid therefrom, and wherein the combustion cylinder comprises: (i) an inlet valve configured to control intake of compressed working fluid into the combustion cylinder, and (ii) an outlet valve configured to control exhausting of fluid from the combustion cylinder, and a controller configured to change the position during the engine cycle at which the inlet and/or outlet valves open to switch operation of the engine between an active mode and an engine braking mode.

### CROSS REFERENCE TO RELATED APPLICATIONS

This application is a continuation of U.S. application Ser. No. 18/689,361, filed Mar. 5, 2024, which is a national stage entry of International Patent Application No. PCT/GB2022/052263, filed Sep. 6, 2022, which claims priority to and benefit of GB Patent Application No. 2112643.8, filed Sep. 6, 2021, the disclosures of which are now expressly incorporated herein by reference in their entireties.

### TECHNICAL FIELD

The present disclosure relates to the field of split cycle internal combustion engines.

### BACKGROUND

Four-stroke internal combustion engines utilise one cylinder to provide both compression and combustion strokes of the engine. Split cycle internal combustion engines utilise a different approach to this. In particular, a split cycle engine has separate cylinders for compression and combustion. Working fluid is compressed in the compression cylinder, and then transported to the combustion cylinder. Fuel is added to the combustion cylinder so that the fuel combusts in the combustion cylinder causing the working fluid to expand to drive movement of a combustion piston in the combustion cylinder. The present disclosure provides improvements to such split cycle internal combustion engines.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect, there is provided a split cycle internal combustion engine comprising: a compression cylinder accommodating a compression piston configured to provide compressed working fluid; a combustion cylinder accommodating a combustion piston, wherein the combustion cylinder is coupled to the compression cylinder to receive compressed working fluid therefrom, and wherein the combustion cylinder comprises: (i) an inlet valve configured to control intake of compressed working fluid into the combustion cylinder, and (ii) an outlet valve configured to control exhausting of fluid from the combustion cylinder; and a controller configured to change the position during the engine cycle at which the inlet and/or outlet valves open to switch operation of the engine between an active mode and an engine braking mode. The controller is configured to control at least one of: the inlet valve to open at a position which is closer to a bottom dead centre, BDC, position when operating in the engine braking mode than when operating in the active mode; and the outlet valve to open at a position which is closer to a top dead centre, TDC, position when operating in the engine braking mode than when operating in the active mode.

Embodiments may enable a split cycle internal combustion to operate to provide engine braking, in addition to generating active driving force using the engine. The engine may be provided as part of a vehicle (e.g. a car, lorry etc.). Where such a split cycle internal combustion engine is used in a vehicle, that engine braking could be used to supplement retardation of the vehicle using other means (such as by clamping brake pads onto a disc surface of a moving wheel). In which case, using the engine to provide split cycle engine may reduce wear to other components of the vehicle (such as brake pads or a disc rotor). Such engine braking may also be used to enable useful energy to be harnessed from the engine while the engine is still running but not being actively driven. For example, the engine braking may generate a pressurised gas which could be used to provide meaningful work, such as by driving movement of a turbine of the engine (once the engine is in an active mode again). This may provide for a more energy efficient engine (and thus vehicle, if the engine is used as part of that vehicle).

The controller may be configured to control the position at which the inlet valve opens and/or closes in the engine braking mode so that working fluid is being further compressed in the combustion cylinder for a majority of the movement of the combustion piston from its BDC position to its TDC position. For example, the difference in internal volume of the combustion cylinder between the position at which the inlet valve shuts and the outlet valve opens may be more than half of the difference in internal volume of the combustion cylinder between the BDC position and TDC position for the combustion piston. In other words, the inlet valve may close at a position close to BDC and the outlet valve may open at a position close to TDC.

The controller may be configured to control the position at which the outlet valve opens and/or closes in the engine braking mode so that further compressed fluid is exhausted from the combustion cylinder. In other words, no combustion may be occurring in the combustion cylinder in the engine braking mode, and the fluid being exhausted may be compressed fluid from the compression cylinder which has also been compressed in the combustion cylinder.

Combustion in the combustion cylinder may comprise oxidation and consumption of a fuel for releasing energy (e.g. for providing kinetic energy). The controller may be configured to control the outlet valve to open at a position before the TDC position in the engine braking mode. For example, this may enable at least some of the stroke of the combustion piston from BDC to TDC may act to push further compressed fluid out through the outlet valve. Some of this further compressed fluid exhausted from the combustion cylinder may then be used downstream in the engine, such as for being stored as pressurised gas, as driving turbine etc. By opening the outlet valve at, or close to TDC, the amount of further compression provided in the combustion cylinder may be increased (it will be closer to the maximum amount of compression available).

The controller may be configured to control the outlet valve to close at a position after the TDC position in the engine braking mode. For example, at least some of the stroke of the combustion piston from TDC to BDC may act to draw exhausted further compressed fluid back into the combustion cylinder through the outlet valve.

The controller may be configured to change the position during the engine cycle at which the inlet and/or outlet valves close when switching operation between the active mode and the engine braking mode. The controller may be configured to change the opening and closing positions by the same amount when switching between the active mode and the engine braking mode. For example, there may be a fixed and constant positional offset in opening and closing positions (when acting in both active and engine braking modes). The engine may further comprise a fuel reservoir and may be configured to inject fuel for combustion in the combustion cylinder. The controller may be configured to control injecting of fuel so that no fuel is injected when operating in the engine braking mode.

The controller may be configured to receive a demand signal for demand from the engine. The controller may be configured to control operation of the engine to be in either the active mode or the engine braking mode based on the demand signal. The controller may be configured to control opening and/or closing positions for at least one of the inlet valve and the outlet valve based on the demand signal. For example, the controller may be configured to select the amount of engine braking being provided and/or act to regulate the temperature of the engine based on the demand signal. The engine may be for a vehicle (e.g. a car, a lorry, a train etc.) and the demand signal may comprise an indication that at least one of: (i) retardation of the vehicle is wanted, and (ii) no further acceleration of the vehicle is wanted.

The compression cylinder may be coupled to the combustion cylinder via a recuperator. The recuperator may be arranged to provide a heat exchange between fluid which has been exhausted from the combustion cylinder and compressed working fluid travelling from the compression cylinder to the combustion cylinder. The engine may comprise a recuperator bypass passage (e.g. which defines a path for fluid flowing through the engine which avoids the recuperator, such as to reduce the amount of heat exchange occurring). The controller may be configured to receive a signal indicative of a temperature of the recuperator and to control operation of the recuperator bypass passage based on said received signal. The controller may be configured to control a proportion of the fluid which flows through the recuperator in dependence on the received signal.

The controller may be configured to control operation of the engine so that at least some fluid travels through the recuperator bypass passage when operating in the engine braking mode.

For example, selectively using the recuperator bypass passage may enable selective control of engine temperature (especially temperature of the recuperator itself). By keeping the recuperator temperature in a selected range (keeping it hot), when the engine returns to active mode, the recuperator may be at a better temperature to restart operation than it otherwise would have been.

If the further compressed fluid exhausted from the combustion cylinder is very hot, then some of this fluid may be directed away from the recuperator to avoid the recuperator getting too hot and/or to avoid overheating compressed fluid about to be further compressed in the combustion cylinder. If the compressed working fluid is cold (and the recuperator is also getting too cold), compressed working fluid may travel from compression cylinder to combustion cylinder while avoiding the recuperator to avoid cooling down the recuperator too much. Likewise, this compressed working fluid may be directed to avoid the recuperator if the recuperator is very hot and would overheat this fluid.

The recuperator bypass passage may comprise at least one of: a high-pressure bypass passage arranged to provide a flow path for compressed fluid from the compression cylinder to the combustion cylinder which avoids the recuperator; and a low-pressure bypass passage arranged to provide a flow path for fluid exhausted from the combustion cylinder which avoids the recuperator. The controller may be configured to control operation of the engine so that fluid flows through the high-pressure bypass passage in the event that a temperature associated with the recuperator drops below a threshold value. For example, the controller may act to avoid the recuperator temperature reducing too much (or getting too low) by reducing the amount of the cooling effect provided by cooler compressed working fluid passing through the recuperator between the compression cylinder and the combustion cylinder. The controller may be configured to control operation of the engine so that fluid flows through the low-pressure bypass passage in the event that a temperature and/or pressure associated with working fluid exceeds a threshold value. For example, the controller may act to avoid the recuperator temperature increasing too much (or getting too high) by reducing the heating effect provided by hot further compressed fluid which has been exhausted from the combustion cylinder passing through the recuperator between the combustion cylinder and an exhaust of the engine.

The controller may be configured to receive a signal indicative of a temperature of the recuperator and to select the position during the engine cycle at which the outlet valve closes based on said received signal. The controller may be configured to select the position to be closer to BDC than TDC to increase the temperature of the recuperator. The controller may be configured to control operation of the engine so that the temperature of the recuperator exceeds a threshold value. Said threshold value may be selected to provide a catalytic event in the recuperator. For example, a coating may be provided inside the recuperator which includes a catalytic substance. Heating the recuperator, and thus the catalyst, above a certain temperature may cause a catalytic event to occur. Such a catalytic event may improve engine performance by increasing operational efficiency of the catalyst, or may reduce the environmental impact of the engine (e.g. the amount of particulates/environmental contaminants generated when operating the engine).

The engine may further comprise a turbocharger having: (i) a turbine arranged to be driven by fluid exhausted from the combustion cylinder, and (ii) a compressor configured to force additional compressed fluid into the compression cylinder. The engine may further comprise a turbine bypass passage arranged to provide a flow path for fluid exhausted from the combustion cylinder which avoids the turbine. The controller may be configured to control operation of the turbine bypass passage to provide a selected amount of compressed working fluid be provided to the compression cylinder. The controller may be configured to control operation of the engine so that at least some fluid travels through the turbine bypass passage when operating in the engine braking mode. The controller may be configured to control a proportion of fluid travelling though the turbine bypass passage to provide a selected amount of engine braking per engine cycle.

The engine may further comprise a compressed gas storage unit arranged to receive gas compressed by the engine. The compressed gas storage unit may comprise one or more storage units arranged to receive compressed gas which has been compressed in the compression cylinder and/or further compressed gas which has been further compressed in the combustion cylinder. The controller may be configured to control operation of the engine to provide compressed gas to the compressed gas store when operating in the engine braking mode. The controller may be configured to control operation of the compressed gas store to selectively release gas from the compressed gas store to increase engine output. The controller may be configured to control operation of the compressed gas store to release gas from the compressed gas store in response to switching from the engine braking mode to the active mode. The engine may comprise one or more phase change materials configured to store excess energy from the engine when operating in the engine braking mode. For example, the phase change material may be provided in the recuperator.

In an aspect, there is provided a method of operating a split cycle internal combustion engine.

The split cycle internal combustion engine comprises: a compression cylinder accommodating a compression piston configured to provide compressed working fluid; and a combustion cylinder accommodating a combustion piston, wherein the combustion cylinder is coupled to the compression cylinder to receive compressed working fluid therefrom, and wherein the combustion cylinder comprises: (i) an inlet valve configured to control intake of compressed working fluid into the combustion cylinder, and (ii) an outlet valve configured to control exhausting of fluid from the combustion cylinder. The method comprises changing the position during the engine cycle at which the inlet and/or outlet valves open to switch operation of the engine between an active mode and an engine braking mode, and controlling at least one of: the inlet valve to open at a position which is closer to a bottom dead centre, BDC, position when operating in the engine braking mode than when operating in the active mode; and the outlet valve to open at a position which is closer to a top dead centre, TDC, position when operating in the engine braking mode than when operating in the active mode.

Aspects of the present disclosure provide computer program products comprising computer program instructions configured to program a processor to control operation of a split cycle internal combustion engine to perform any of the methods disclosed herein.

### BRIEF DESCRIPTION OF THE FIGURES

Some examples of the present disclosure will now be described, by way of example only, with reference to the figures, in which:

FIG. 1 is a schematic diagram of a split cycle internal combustion engine.

FIG. 2 is a schematic diagram of a split cycle internal combustion engine.

FIG. 3a shows an exemplary timing diagram for the opening and closing of inlet and outlet valves of a combustion cylinder of a split cycle internal combustion engine.

FIG. 3b shows an exemplary timing diagram for the opening and closing of inlet and outlet valves of a combustion cylinder of a split cycle internal combustion engine.

FIG. 3c shows an exemplary timing diagram for the opening and closing of inlet and outlet valves of a combustion cylinder of a split cycle internal combustion engine.

FIG. 3d shows an exemplary timing diagram for the opening and closing of inlet and outlet valves of a combustion cylinder of a split cycle internal combustion engine.

In the drawings like reference numerals are used to indicate like elements.

### DETAILED DESCRIPTION OF CERTAIN EMBODIMENTS

The present disclosure is directed to a split cycle internal combustion engine which may operate in two different modes. The first mode is an active mode, and the second mode is an engine braking mode. In both modes, working fluid is compressed in the compression cylinder, and this working fluid is provided to the combustion cylinder. In the active mode, fuel is combusted in the combustion cylinder and the combusted working fluid is used to drive movement of the combustion piston. In the engine braking mode, operation of the combustion cylinder is changed so that the combustion cylinder is instead used to further compress the working fluid. The timing for opening and/or closing of an inlet valve to the combustion cylinder is changed between the two modes so that, in the engine braking mode, working fluid in the combustion cylinder is further compressed, and this compressed fluid is then exhausted from the combustion cylinder.

Further features of the present disclosure provide control mechanisms for regulating operating temperatures of one or more parts of the engine when operating in the engine braking mode.

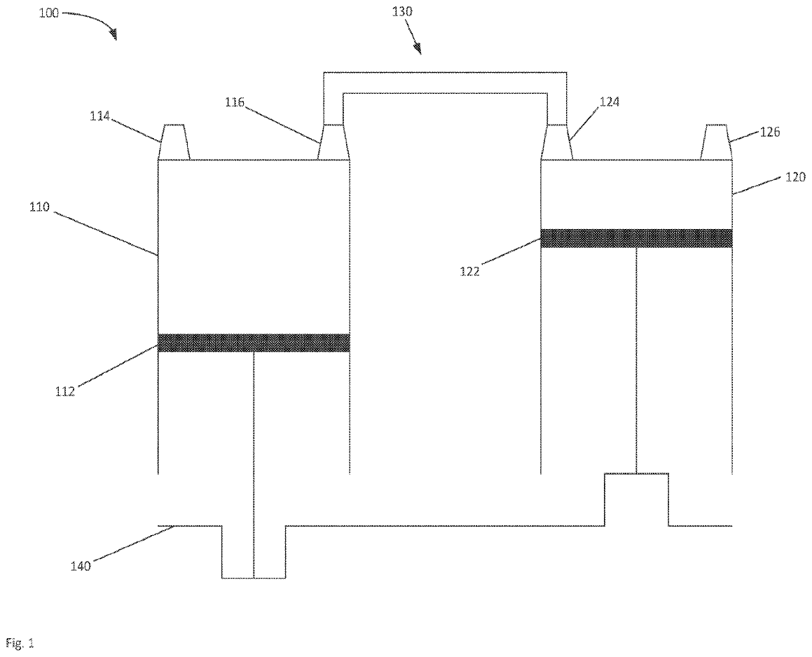

FIG. 1 shows a split cycle internal combustion engine 100. The engine 100 includes a compression cylinder 110, a combustion cylinder 120, and a crossover passage 130. The compression cylinder 110 includes a compression piston 112, an inlet valve 114, and an outlet valve 116. The combustion cylinder 120 includes a combustion piston 122, an inlet valve 124, and an outlet valve 126. The engine 100 also includes a crankshaft 140.

The compression cylinder 110 accommodates the compression piston 112 and the combustion cylinder 120 accommodates the combustion piston 122. Both the compression piston 112 and the combustion piston 122 are coupled to the crankshaft 140. The compression cylinder 110 is coupled to the combustion cylinder 120 via the crossover passage 130. In particular, the crossover passage 130 is coupled to the outlet valve 116 of the compression cylinder 110 and the inlet valve 124 of the combustion cylinder 120. The inlet valve 114 of the compression cylinder 110 is coupled to a source of incoming working fluid. The outlet valve 126 of the combustion cylinder 120 is coupled to an exhaust of the engine 100. The crossover passage 130 provides a conduit through which working fluid travels from the compression cylinder 110 to the combustion cylinder 120.

The compression cylinder 110 is arranged to provide compression of working fluid. The inlet valve 114 of the compression cylinder 110 is configured to open to let working fluid enter the compression cylinder 110 and to close to enable the compression piston 112 to move to compress the working fluid in the compression cylinder 110. The compression piston 112 is arranged to move to reduce the volume in the compression cylinder 110 to compress the working fluid therein. The compression piston 112 is coupled to the crankshaft 140 so that this movement of the compression piston 112 occurs due to rotational motion of the crankshaft 140. The outlet valve 116 of the compression cylinder 110 is configured to remain closed to enable compression of working fluid in the compression cylinder 110 and to open to output compressed fluid from the compression cylinder 110.

The crossover passage 130 is configured to receive the compressed fluid from the compression cylinder 110. The crossover passage 130 may provide heating of this compressed fluid. The inlet valve 124 of the combustion cylinder 120 is arranged to open to let compressed working fluid enter the combustion cylinder 120 from the crossover passage 130 and to close to inhibit working fluid from entering the combustion cylinder 120 from the crossover passage 130. The outlet valve 126 of the combustion cylinder 120 is configured to open to exhaust fluid from the combustion cylinder 120 and to close to inhibit exhausting of fluid from the combustion cylinder 120.

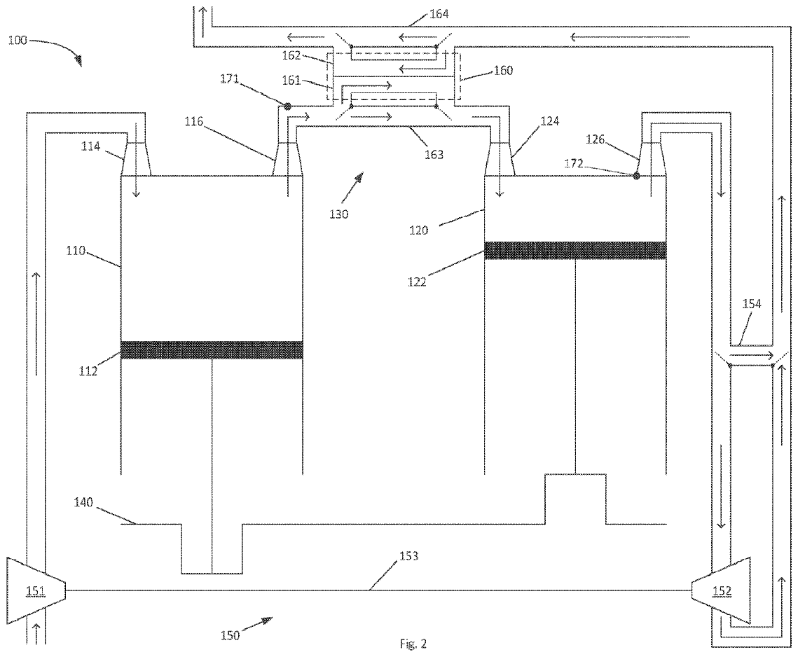

Although not shown in FIG. 1, the engine 100 also includes a controller. The engine 100 may also include one or more sensors which provide an indication of a sensed parameter to the controller (e.g. to enable the controller to control operation of the engine 100 based on such sensed parameters). This will be described in more detail below in relation to the engine 100 shown in FIG. 2.

The controller is configured to control the engine 100 to operate in two different operational modes. The first operational mode is an active mode. The second operational mode is an engine braking mode.

In the active mode, the controller is configured to control operation of the engine 100 so that compressed working fluid enters the combustion cylinder 120 from the crossover passage 130, and combustion occurs in the combustion cylinder 120. Combustion in the combustion cylinder comprises oxidation and consumption of a fuel for releasing energy (e.g. for consuming the fuel to provide potential energy in the pressure of the working fluid, and kinetic energy of the combustion piston/crankshaft). This combustion may provide an exothermic reaction. That combustion provides expansion movement of the working fluid to drive movement of the combustion piston 122 (and thus movement of the crankshaft 140). The combusted (and expanded) fluid is then exhausted from the combustion cylinder 120.

In the engine braking mode, the controller is configured to control operation of the engine 100 so that compressed working fluid enters the combustion cylinder 120 from the crossover passage 130, and that compressed working fluid is then further compressed in the combustion cylinder 120 by movement of the combustion piston 122. The further compressed fluid is then exhausted from the combustion cylinder 120 (without any combustion occurring).

The controller is configured to change the opening and/or closing positions for the inlet and/or outlet valve of the combustion cylinder 120 to switch between the different operational modes.

To describe the switching of valve timings/positions, reference is first made to motion of the combustion piston 122. The combustion piston 122 is configured to move between a bottom dead centre (‘BDC’) position and a top dead centre (‘TDC’) position. With the combustion piston 122 in its BDC position, the internal volume of the combustion cylinder 120 will be at it its greatest during the cycle of the engine 100. In the engine 100 of FIG. 1, the combustion piston 122 will be at its lowest point in the combustion cylinder 120 when in the BDC position.

That is, the head of the combustion piston 122 (as shown in black fill in FIG. 1) will be towards the bottom end of the combustion cylinder 120, e.g. at its closest position to the shaft of the crankshaft 140. With the combustion piston 122 in its TDC position, the internal volume of the combustion cylinder 120 will be at its smallest during the cycle of the engine 100. In the engine 100 of FIG. 1, the combustion piston 122 will be at its highest point in the combustion cylinder 120 when in the TDC position. That is, the head of the combustion piston 122 will be towards the top end of the combustion cylinder 120, e.g. at its further position from the shaft of the crankshaft 140.

This process is cyclical, e.g. it keeps repeating. In the engine 100 of FIG. 1, the cyclical process involves reciprocating motion of the combustion piston 122 within the combustion cylinder 120.

This cyclical process will also include rotational motion of the crankshaft 140 with the reciprocal movement of the combustion piston 122. The motion of the combustion piston 122 is such that it will pass repeatedly through its TDC and BDC positions. In other words, the combustion piston 122 moves reciprocally within the combustion cylinder 120 between BDC and TDC position (e.g. as it moves back and forwards within the combustion cylinder 120). The BDC and TDC positions may expressed as angles (e.g. for the position of oscillatory movement of the combustion piston 122). In this sense, TDC will be considered to be 0° or 360° (they are the same), and the BDC position will be 180°. The piston moves from 0°, through 180° and up to 360° (which is the same as 0°), and then repeats this motion.

The controller is configured to control the position during this engine cycle at which the inlet and/or outlet valve of the combustion cylinder 120 open and/or close. Again, the position at which these valves open/close may be expressed as an angle to show how far through the cycle the combustion piston 122 is. The valves may be arranged to open and/or close using a hydraulic and/or pneumatic system, or they may be coupled to a cam shaft whose rotation controls opening and closing of the valves. The controller may be arranged to adjust the operation of the relevant component to change the position at which the valves open and/or close.

For the active mode, the controller is configured to control the inlet valve 124 of the combustion cylinder 120 to open at around the TDC position (e.g. the inlet valve 124 may be open for some time between 340° and 20°). The inlet valve 124 of the combustion cylinder 120 is arranged to be opened and closed so that, after combustion has occurred, the working fluid which was taken into the combustion cylinder 120 may drive movement of the combustion piston 122 for a majority of the distance between the TDC and BDC position. For example, the inlet valve 124 of the combustion cylinder 120 may be configured to open at, or shortly before, TDC, and to close at, or shortly after, TDC.

For the active mode, the controller is configured to control the outlet valve 126 of the combustion cylinder 120 to open towards the BDC position. The outlet valve 126 of the combustion cylinder 120 is arranged to be opened so that the fluid being exhausted from the combustion cylinder 120 is combusted and expanded fluid (e.g. so that a majority of combustion and/or movement towards BDC from TDC has occurred before the outlet valve 126 is opened).

The controller is configured to control the outlet valve 126 of the combustion cylinder 120 to close towards the TDC position. The outlet valve 126 of the combustion cylinder 120 is arranged to be closed so that a majority of the combusted and expanded fluid is exhausted from the combustion cylinder 120 before the outlet valve 126 of the combustion cylinder 120 is closed.

The controller may be configured to control operation of the engine 100 to minimise (e.g. avoid altogether) the amount of time for which the outlet and inlet valves of the combustion cylinder 120 are open together. For example, the inlet valve 124 of the combustion cylinder 120 may open at the same time that the outlet valve 126 of the combustion cylinder 120 closes, or at a position shortly after. The lag between the inlet valve 124 of the combustion cylinder 120 shutting and the outlet valve 126 opening will be larger (e.g. to enable the combustion and expansion to drive the combustion piston 122 for a majority of the way from TDC to BDC).

In the active mode, the engine 100 is arranged to inject fuel into the combustion cylinder 120.

The fuel will mix with working fluid in the combustion cylinder 120, and the fuel will be combusted (e.g. oxidised) to provide expansion of the working fluid, and to drive movement of the combustion piston 122 to its BDC position. In the active mode, the controller is configured to control the inlet and outlet valves of the combustion cylinder 120 to open and close such that at, or shortly after, TDC, the fuel is combusted in the combustion cylinder 120 and the compressed working fluid in the combustion cylinder 120 expands to drive movement of the combustion piston 122 towards its TDC position. Likewise, in the active mode, the controller is configured to control the inlet and outlet valves of the combustion cylinder 120 to open and close such that the expanded and combusted working fluid is exhausted from the combustion cylinder 120 (e.g. so that a majority of the expanded and combusted working fluid is exhausted from the combustion cylinder 120), before new compressed working fluid to be expanded is taken into the combustion cylinder 120.

By controlling the engine 100 in this way in the active mode, operation of the engine 100 may provide a motive output (e.g. through the rotational motion of the crankshaft 140). This output (e.g. a driving torque) may be utilised in a number of ways, such as to drive motion of a vehicle (e.g. a lorry). The controller may be configured to receive a demand signal indicating an amount of demand for the engine 100 (e.g. an amount of torque output required). The controller may control operation of the engine 100 based on this demand signal, such as quantities and timing for fuel injection.

During operation of the engine 100, the demand for immediate output from the engine 100 may vary. For example, where the engine 100 is used in a vehicle, the demand for torque output from the engine 100 may be reduced when retardation of the vehicle is wanted (e.g. to slow down, or when no more acceleration is wanted). During such times, the crankshaft 140 may still be rotating, causing movement of the combustion piston 122. To facilitate in this slowing down of the engine 100 (e.g. retardation of the vehicle), and/or to extract usable work from the operation of the engine 100 during this time, the controller is configured to switch operation of the engine 100 from the active mode to the engine braking mode. For example, the controller may receive a signal indicating that output from the engine 100 is to be reduced, and in response to receiving this signal, the controller may control operation of the engine 100 to switch from the active mode to the engine braking mode.

The controller is configured to change the opening and/or closing positions of the inlet and/or outlet valves of the combustion cylinder 120 to switch between the active mode and the engine braking mode.

For the engine braking mode, the controller is configured to control the inlet valve 124 of the combustion cylinder 120 to open at around the BDC position. The inlet valve 124 of the combustion cylinder 120 may open at, or shortly after, BDC. For example, the inlet valve 124 may open at around 190°. The controller is configured to control the inlet valve 124 of the combustion cylinder 120 to be opened and closed so that compressed fluid passes from the crossover passage 130 into the combustion cylinder 120, and that compressed fluid is then further compressed within the combustion cylinder 120 as the combustion piston 122 moves towards its BDC position. For example, working fluid may be compressed in the combustion cylinder 120 for a majority of the movement of the combustion piston 122 from its BDC position to its TDC position. The opening and closing positions for the inlet valve 124 of the combustion cylinder 120 may have a fixed offset from each other (e.g. which remains constant when in both the active and engine braking modes), but their positions during the engine cycle may change.

In other words, the controller is configured to control the inlet valve 124 of the combustion cylinder 120 to open at a position which is closer to the BDC position of the combustion piston 122 when in the engine braking mode (e.g. at a position which is around, or shortly after, BDC), as compared to the active mode (e.g. when the inlet valve 124 is opened at a position around TDC). In so doing, some of the movement of the combustion piston 122 from its BDC position to its TDC position will act to provide further compression of compressed working fluid in the combustion cylinder 120 to provide engine braking.

For the engine braking mode, the controller is configured to control the outlet valve 126 of the combustion cylinder 120 to open at or before the TDC position. The outlet valve 126 of the combustion cylinder 120 may open at a position closer to TDC than to BDC. For example, the outlet valve 126 of the combustion cylinder 120 may open between approximately 290° and 300°. The outlet valve 126 of the combustion cylinder 120 may be controlled to open before TDC so that further compressed fluid (e.g. working fluid which was compressed in the compression cylinder 110 and which was then further compressed in the combustion cylinder 120) is driven out through the outlet valve 126 due to movement of the combustion piston 122 towards its TDC position. The outlet valve 126 of the combustion cylinder 120 is controlled to be closed before the inlet valve 124 opens. The outlet valve 126 of the combustion cylinder 120 may be opened before the combustion piston 122 reaches its BDC position (e.g. at about 140°). The outlet valve 126 may be controlled to open at a position so that gas remaining in the combustion cylinder 120 is expanded as the combustion piston 122 moves towards TDC before the inlet valve 124 of the combustion cylinder 120 is opened to allow more working fluid to enter the combustion cylinder 120.

The controller may be configured to control operation of the engine 100 to avoid any overlap in position between the position at which the inlet valve 124 of the combustion cylinder 120 closes and the outlet valve 126 opens and/or the position at which the outlet valve 126 closes and the inlet valve 124 opens. The time lag between the inlet valve 124 closing and the outlet valve 126 opening may be selected to provide a selected amount of compression of working fluid within the combustion cylinder 120.

In other words, the controller is configured to control the outlet valve 126 of the combustion cylinder 120 to open at a position which is closer to a top dead centre, TDC, position (e.g. at a position which is around, or shortly before, TDC) when operating in the engine braking mode than when operating in the active mode (e.g. when the outlet valve 126 is opened is opened at a position around, or shortly before, BDC). In so doing, some of the movement of the combustion piston 122 from its BDC position to its TDC position will act to provide further compression of compressed working fluid in the combustion cylinder 120 to provide engine braking.

In the engine braking mode, no fuel is injected into the combustion cylinder 120. For example, the controller may be configured to control operation of both the inlet/outlet valve positioning and the injection of fuel. In the event that the controller is controlling operation of the engine 100 to be in the engine braking mode, the controller may control the fuel injection so that no fuel is injected into the combustion cylinder 120. In this sense, the engine 100 may operate to provide double compression of working fluid, e.g. because the working fluid is first compressed in the compression cylinder 110 and then second compressed in the combustion cylinder 120 without any combustion driven expansion of that working fluid occurring. This double compressed working fluid is then exhausted through the outlet valve 126 of the combustion cylinder 120.

In the engine braking mode, the controller is configured to control the inlet and outlet valves of the combustion cylinder 120 to open and close such that, for a period between the BDC and TDC positions of the combustion piston 122, working fluid in the compression cylinder 110 is compressed as the combustion piston 122 moves towards its TDC position. Likewise, in the engine braking mode, the controller is configured to control the inlet and outlet valves of the combustion cylinder 120 to open and close such that this further compressed fluid in the combustion cylinder 120 is exhausted through the outlet valve 126 (e.g. without any combustion-induced expansion of the working fluid occurring in the combustion cylinder 120).

As such, operation of the engine 100 may be controlled to switch between an active mode and an engine braking mode. The controller may be configured to initiate such a switch in response to receiving a signal indicating that such a switch is wanted (e.g. in response to a driver of a vehicle acting to retard the vehicle or to avoid further acceleration of the vehicle).

In operation, the engine 100 may be controlled to operate in one of the two different modes.

For example, operation of the engine 100 may start in the active mode. In so doing, the inlet valve 114 of the compression cylinder 110 is opened, with the outlet valve 116 of the compression cylinder 110 closed, to admit working fluid into the compression cylinder 110. The inlet valve 114 of the compression cylinder 110 is then closed. The compression piston 112 moves to compress the working fluid in the compression cylinder 110. The outlet valve 116 of the compression piston 112 is then opened, and the compressed working fluid passes from the compression cylinder 110 into the crossover passage 130. Once the inlet valve 124 of the combustion cylinder 120 is opened (at around a TDC position for the combustion piston 122), the compressed working fluid enters the combustion cylinder 120 from the crossover passage 130 and is mixed with fuel. The fuel is combusted (e.g. oxidised), which causes expansion of the working fluid to drive the combustion piston 122 towards its BDC position. The outlet valve 126 of the combustion cylinder 120 is then opened (before the BDC position), and it remains open until shortly before the inlet valve 124 of the combustion cylinder 120 will be opened (before the TDC position). While the outlet valve 126 is open, the combusted and expanded working fluid is then exhausted from the combustion cylinder 120. The driven movement of the combustion piston 122 is transferred to the crankshaft 140, and this may be utilised to extract work from the engine 100.

The controller may then receive a signal that operation in the engine braking mode is wanted. In so doing, the controller changes the opening and/or closing times for the inlet and/or outlet valves of the combustion cylinder 120. Operation of the compression cylinder 110 may be similar in both modes (i.e. to provide compressed working fluid to the combustion cylinder 120).

In the active mode, the inlet valve 124 of the combustion cylinder 120 is opened nearer to the BDC position (as compared to the active mode). Compressed working fluid then enters the combustion cylinder 120 from the crossover passage 130 while the outlet valve 126 is closed, and the combustion piston 122 is closer to a BDC position. The inlet valve 124 of the combustion cylinder 120 is then closed and the working fluid in the combustion cylinder 120 is compressed as the combustion piston 122 moves towards its TDC position. The outlet valve 126 is then opened at a position at, or before, the TDC position of the combustion piston 122. The working fluid which has been further compressed in the combustion cylinder 120 is then exhausted through the outlet valve 126. The work done in further compressing working fluid in the combustion cylinder 120 provides engine braking.

With reference to FIG. 2, a number of additional and optional features of the disclosure will now be described.

FIG. 2 shows a split cycle internal combustion engine 100. The engine 100 of FIG. 2 is similar to that of FIG. 1, and similar components of the engine 100 will not be described again.

In addition to the features shown in FIG. 1, the engine 100 may include a turbocharger 150. The turbocharger 150 includes a compressor 151, a turbine 152, and a shaft 153. The engine 100 may also include a turbine bypass passage 154.

The engine 100 may include a recuperator 160. The recuperator 160 is a heat exchanger having two heat exchange passages: a high-pressure heat exchange passage 161 and a low-pressure heat exchange passage 162. The recuperator 160 may include one or more bypass passages.

FIG. 2 shows both a high-pressure recuperator bypass passage 163 and a low-pressure recuperator bypass passage 164.

The engine 100 may also include an energy storage apparatus. Although not shown, the engine 100 may include one or more compressed gas storage units. Two exemplary gas collection points are shown in FIG. 2: first gas collection point 171 and second gas collection point 172.

Arrows are shown in FIG. 2 to illustrate an indication of possible directions of flow of working fluid through the engine 100. Conduits are also shown for housing this moving working fluid through the engine 100. It is to be appreciated that these features are not intended to be limiting, but they are just shown to help illustrate the functionality and operation of the engine 100.

The compressor 151 is coupled to the turbine 152 via the shaft 153. The compressor 151 is arranged to be in fluid communication with working fluid to be provided to the inlet valve 114 of the compression cylinder 110. The turbine 152 is arranged to be in fluid communication with working fluid exhausted from the outlet valve 126 of the combustion cylinder 120. The turbine 152 is located between the outlet valve 126 of the combustion cylinder 120 and an exhaust of the engine 100. The turbine bypass passage 154 is located between the outlet valve 126 of the combustion cylinder 120 and the turbine 152. The turbine bypass passage 154 couples a region upstream of the turbine 152 (e.g. between the outlet valve 126 of the combustion cylinder 120 and the turbine 152) to a region downstream of the turbine 152 (e.g. between the turbine 152 and the exhaust of the engine 100). One or more actuators, such as valves, are provided for selectively opening or closing the turbine bypass passage 154. In FIG. 2, these are shown as small black circles with a dashed line extending therefrom.

The high and low pressure heat exchange passages of the recuperator 160 are located adjacent to one another. For simplicity, these are shown in FIG. 2 as two passages which are in contact with each other, and which run parallel to one another. However, it is to be appreciated that other arrangements may be provided (e.g. to increase exchange of heat between the two passages).

The outlet valve 116 of the compression cylinder 110 is coupled to the inlet valve 124 of the combustion cylinder 120 via the high-pressure heat exchange passage 161 of the recuperator 160 and the high-pressure recuperator bypass passage 163. In other words, two passages are provided between the outlet valve 116 of the compression cylinder 110 and the inlet valve 124 of the combustion cylinder 120. One of these passages (the high-pressure heat exchange passage 161) runs through the recuperator 160, such as to bring working fluid into close proximity to exhausted fluid to provide heat exchange therebetween. The other of these passages (the high-pressure recuperator bypass passage 163) provides a flow path which avoids running through the recuperator 160 (and is located away from exhausted fluid, to reduce heat exchange therebetween).

The outlet valve 126 of the combustion cylinder 120 is coupled to the exhaust of the engine 100 via the low-pressure heat exchange passage 162 of the recuperator 160 and the low-pressure recuperator bypass passage 164. In the example of FIG. 2, the turbine 152 and turbine bypass passage 154 are also included, and these are arranged between the outlet valve 126 of the combustion cylinder 120 and the two low-pressure passages (although it is to be appreciated that this need not be the case, and e.g. the arrangement could be reversed so that exhausted fluid first flows through the low pressure passages before reaching the turbine 152/turbine bypass passage 154). The low-pressure heat exchange passage 162 runs through the recuperator 160, such as to bring exhausted fluid from the combustion cylinder 120 into close proximity to compressed working fluid from the compression cylinder 110 to provide heat exchange therebetween. The low-pressure recuperator bypass passage 164 provides a flow path which avoids running through the recuperator 160 (and is located away from the compressed working fluid from the compression cylinder 110, to reduce heat exchange therebetween).

The first and second gas collection points may comprise valves and/or pumps to channel pressurised gas into a pressurised gas storage unit. They are shown in FIG. 2 at high pressure regions of the engine 100. The first gas collection point 171 is arranged to receive gas which has just been compressed in the compression cylinder 110. In FIG. 2, the first gas collection point 171 is shown just downstream of the compression cylinder 110 (i.e. it is coupled to the outlet valve 116 of the compression cylinder 110 and/or the conduit extending therefrom). The second gas collection point 172 is arranged to receive gas which has just been compressed in the combustion cylinder 120. In FIG. 2, the second gas collection point 172 is shown adjacent to the outlet valve 126 (e.g. on the high pressure side of the outlet valve 126, or within the outlet valve 126 so that the gas pressure is high). Each gas collection point may be coupled to the pressurised gas storage tank via another conduit. The engine 100 may comprise one or more pressurised gas storage tanks (e.g. both collection points may be coupled to the same tank, or each collection point may be coupled to a respective tank).

The turbocharger 150 is arranged to enable further work to be extracted by working fluid exhausted from the combustion cylinder 120. The engine 100 is arranged so that this exhausted fluid may flow from the combustion cylinder 120 and past the turbine 152 to drive rotation of the turbine 152. The turbocharger 150 is arranged so that rotation of the turbine 152 drives a rotation of the shaft 153, which in turn drives rotation of the compressor 151. The compressor 151 is arranged to selectively drive working fluid towards the inlet valve 114 of the compression cylinder 110. Increased rotation of the compressor 151 will drive more working fluid towards the compression cylinder 110 (e.g. it will increase the pressure of working fluid being delivered to the compression cylinder 110). In other words, the turbocharger 150 is configured to use energy from the flow of exhausted working fluid from the combustion cylinder 120 past the turbine 152 to increase compression of working fluid being supplied to the compression cylinder 110.

The turbine bypass passage 154 is arranged to provide an alternative flow path for exhausted fluid from the combustion cylinder 120 which avoids, or at least reduces, the interaction between that exhausted fluid and the turbine 152. In other words, the turbine bypass passage 154 is arranged to provide a passage for exhausted fluid from the combustion cylinder 120 towards the exhaust of the engine 100 while bypassing the turbine 152. The turbocharger 150 may be configured to selectively control whether exhausted fluid flows through the turbine bypass passage 154. The turbocharger 150 may be arranged to select (e.g. vary) an amount or proportion of the exhausted fluid which flows through the turbine bypass passage 154. For example, none, some, or all, of the exhausted fluid may be directed through the turbine bypass passage 154. The controller may be configured to control operation of the turbine bypass passage 154. For example, the controller may be configured to regulate an amount or proportion of working fluid passing through the turbine bypass passage 154 to provide a selected amount of compression by the compressor 151 (e.g. to regulate the amount of working fluid passing through the engine 100).

Additionally, or alternatively, the engine 100 may include one or more vents selectively operable for venting compressed gas to regulate pressure (and temperature of the engine 100). For example, a vent could be provided for the inlet gas (e.g. upstream of the inlet valve 114 of the compression cylinder 110). This vent could be used to reduce pressure of gas flowing through the engine. For example, by increasing the amount of vented gas, the pressure of the gas flowing through the engine may decrease. Any gas which is to be removed from flowing through the engine could be used within the engine e.g. for cooling intake air.

The recuperator 160 is arranged to provide heat exchange between exhausted fluid from the combustion cylinder 120 and compressed fluid between the compression cylinder 110 and the combustion cylinder 120. For example, exhausted fluid flowing through the low-pressure heat exchange passage 162 will typically be hotter than compressed fluid flowing through high-pressure heat exchange passage 161. The recuperator 160 is arranged to enable heat to be transferred between the hotter exhausted fluid in the low-pressure heat exchange passage 162 and the cooler compressed fluid in the high-pressure heat exchange passage 161.

The recuperator bypass passages are arranged to provide fluid flow paths which avoid the recuperator 160 (e.g. to reduce the amount of heat exchange provided between the exhausted fluid and the compressed fluid). In other words, each recuperator bypass passage may provide an alternative flow path for fluid, which avoids the recuperator 160. The engine 100 may be controlled to select the amount or proportion of fluid which passes through each recuperator bypass passage. It is to be appreciated in the context of the present disclosure that only of the recuperator bypass passages may be provided.

The engine 100 may be arranged to select (e.g. vary) an amount or proportion of the compressed fluid from the compression cylinder 110 which flows through the high-pressure recuperator bypass passage 163. For example, none, some, or all, of this compressed fluid may be directed through the high-pressure recuperator bypass passage 163. The controller may be configured to control operation of the high-pressure recuperator bypass passage 163. For example, the controller may be configured to regulate an amount or proportion of working fluid passing through the high-pressure bypass passage to provide a selected amount of heating of the compressed working fluid and/or a selected amount of cooling being provided to the recuperator 160 (and/or exhausted fluid).

The engine 100 may be arranged to select (e.g. vary) an amount or proportion of the exhausted fluid from the combustion cylinder 120 which flows through the low-pressure recuperator bypass passage 164. For example, none, some, or all, of this exhausted fluid may be directed through the low-pressure recuperator bypass passage 164. The controller may be configured to control operation of the low-pressure recuperator bypass passage 164. For example, the controller may be configured to regulate an amount or proportion of working fluid passing through the low-pressure bypass passage to provide a selected amount of heating of the compressed working fluid and/or a selected amount of cooling being provided to the recuperator 160 (and/or exhausted fluid).

The gas collection points may be arranged to enable compressed gas to be delivered to a pressurised gas storage unit of the engine 100. The gas collection points may be located so that they are collected pressurised gas from regions of the engine where gas pressure will be high.

The pressurised gas storage unit may be configured to store pressurised gas and to enable the pressurised gas to be returned to the engine 100. For example, the engine 100 may compress gas intake points and gas return points for providing gas to the storage unit, and from the storage unit back to the engine 100 respectively. The gas collection points may comprise both such intake and return points. Alternatively, one or more gas return points may be provided in regions of the engine where the gas pressure is lower, such as downstream of the outlet valve of the combustion cylinder 120. For example, the engine 100 may be configured to enable pressurised gas to be taken from a position during its flow through the engine 100 (e.g. so that the gas is under pressure from being compressed in the compression cylinder 110 and/or combustion cylinder 120) and stored in the storage unit. The engine 100 may be configured to return pressurised gas back to the engine 100 for further use during operation of the engine 100. For example, the engine 100 may be configured to enable pressurised gas to be return to drive the turbine 152. In other words, the engine 100 may be configured to store gas in the gas storage unit when engine demand is low (e.g. when compressed gas flowing through the engine 100 is not needed for meaningful output from the engine 100). The engine 100 may be configured to return gas to the engine 100 for use in converting to meaningful output when demand is higher (e.g. to provide more compressed gas flowing through the engine 100).

As with the engine 100 of FIG. 1, the engine 100 comprises a controller which is not shown. The engine 100 may also comprise one or more sensors. For example, sensors may be provided to obtain an indication of temperature and/or pressure for one or more components of the engine 100. For example, the controller may be configured to receive an indication of a temperature of the recuperator 160 and/or a pressure of working fluid flowing through the engine 100. The controller may be configured to control operation of the engine 100 based on such a received indication.

The controller may be configured to control one or more components of the engine 100 to provide selected operating characteristics for the engine 100. As with the engine 100 of FIG. 1, the controller is configured to control switching of the engine 100 between the active mode and the engine braking mode. Additionally, the controller may be configured to control operation of one or more of the different components of the engine 100 to provide selected operational characteristics for the engine 100 in one or both of these operating modes. In particular, the controller may be arranged to control operation of the engine 100 in the engine braking mode to regulate a temperature of the recuperator 160. For example, it may be beneficial to keep the recuperator 160 in a selected temperature range (e.g. to keep the recuperator 160 hot, and/or to avoid overheating the recuperator 160) when in the engine braking mode so that the recuperator 160 is at a desired temperature for restarting operation in the active mode (e.g. so that it does not need time to warm up before the engine 100 functions optimally after returning to the active mode).

Some examples of feedback loops for controlling operation of the engine 100 will be described below. In particular, some of these examples relate to mechanisms for controlling operation of the engine 100 when in the engine braking mode. Before the control loops are described, reference will first be made to the different components of the engine 100 and how their operation may influence working conditions of the engine 100.

The amount of heating provided for different components of the engine will vary based on the amount of compressed working fluid flowing through engine. As more fluid is compressed per cycle (e.g. the gas pressure within the engine increases), this may also provide a greater heating effect to components of the engine. For example, if more working fluid is compressed in the compression cylinder 110, then this will increase the temperature of that fluid as it flows through the recuperator 160 (and thus increase the temperature of the recuperator 160 itself). Similarly, the more hot fluid passing through the recuperator, the hotter the recuperator will get (and vice-versa). Components of the engine may be operated to regulate these properties to control temperature of the engine 100, as desired.

The turbocharger 150 is arranged to influence the amount of working fluid which passes through the engine 100 during one cycle of the engine. The turbocharger 150 is configured to regulate the amount of working fluid forced into the compression cylinder 110. More air flowing through the turbine 152 will cause the compressor 151 to force more air into the compression cylinder 110 (and vice-versa). Increasing the amount of air to be compressed in the compression cylinder 110 may increase the temperature of this working fluid and/or its capacity for heating the recuperator 160. As such, by controlling the amount of air which flows through the turbine bypass passage 154, the amount of working fluid and its heating capacity may also be controlled.

In other words, operation of the turbine bypass passage 154 may be controlled to controlling the heating effect of working fluid passing through the engine (e.g. to control the temperature of the recuperator 160). For example, to increase the temperature of the recuperator 160, the engine 100 may be configured to increase the amount of working fluid flowing through the turbine 152 (i.e. to decrease the amount of fluid flowing through the turbine bypass passage 154).

The high-pressure side of the recuperator 160 may be controlled to influence the amount of compressed working fluid from the compression cylinder 110 passing through the high-pressure recuperator heat exchange passage 161. If the working fluid passing through the high-pressure side 161 of the recuperator 160 is cooler than the recuperator 160, this may have a cooling effect on the recuperator 160. If the exhausted fluid passing through the low-pressure side 162 of the recuperator 160 is hotter than the recuperator 160, this may have a heating effect on the recuperator 160. The engine 100 may be configured to vary these two properties (e.g. to balance the heating and cooling effect on the recuperator 160) to provide a desired temperature for the recuperator.

For the high-pressure side 161 of the recuperator, where the compressed working fluid would have a cooling effect on the recuperator, directing more of this compressed working fluid through the high-pressure recuperator bypass passage 163 may act to provide a higher temperature for the recuperator 160 (e.g. to avoid the recuperator temperature dropping as much). For the low-prssure side 162 of the recuperator 160, where the exhausted working fluid would have a heating effect of the recuperator 160, directing more of this hot working fluid through the low-pressure recuperator bypass passage 164 may have a cooling effect on the recuperator 160.

The low-pressure side of the recuperator 160 may be controlled to influence the amount of hot exhausted fluid from the combustion cylinder 120 passing through the low-pressure recuperator heat exchange passage 162. As a greater amount of hotter exhausted fluid passes through the recuperator 160 and into heat exchange with the cooler compressed working fluid, the temperature of the recuperator 160 may rise (or decrease less). Directing more of the compressed working fluid through the low-pressure recuperator bypass passage 164 may act to provide a lower temperature for the recuperator 160 (e.g. to avoid the recuperator temperature rising as much).

Controlling opening and/or closing times for the inlet and/or outlet valves of the combustion cylinder 120 may influence temperature of the recuperator 160. It will be appreciated in the context of the present disclosure that varying the amount of compression in the combustion cylinder 120 will vary the amount of temperature rise (e.g. more compression may lead to a greater temperature rise). Inlet and outlet valve opening/closing may be controlled to provide a selected amount of compression-induced temperature rising. Additionally, or alternatively, controlling the position at which the outlet valve 126 opens and closes may influence the amount of hotter fluid which has been exhausted from the combustion cylinder 120 being drawn back into the combustion cylinder 120 for further compression (and further heating). As the combustion piston 122 moves towards its BDC position with the outlet valve 126 open, some exhausted fluid will be drawn back into the combustion cylinder 120. As exhausted fluid is repeatedly drawn in for further compression, its temperature will raise. By controlling the amount of this recompressing (and reheating), the temperature of the recuperator 160 will vary (as the exhausted fluid, and thus the low-pressure side of the recuperator 160, may increase in temperature with more recompressing of exhausted fluid occurring in the combustion cylinder 120).

Increasing the amount of compressed gas moving into the compressed gas storage unit may decrease the amount of compressed working fluid passing through the engine 100. The temperature of the recuperator 160 may vary in dependence on this (e.g. as cooler compressed fluid from the compression cylinder 110 is diverted instead into gas storage, less fluid will pass through the system). As compressed gas is released back into the engine 100 from the gas storage unit, this may increase the engine output (and raise engine temperature).

The engine 100 may include other features for regulating temperature. For example, the engine 100 may comprise a coolant system (e.g. configured to inject coolant into the compression cylinder 110). Increasing the amount of coolant injection may decrease temperature of the engine 100. The engine 100 may include one or more phase change materials configured to store heat by changing phase. Phase change materials may be used to enable heat stored during operation in the active mode to be released during operation in the engine braking mode (or vice-versa depending on which mode provides higher temperatures).

Several exemplary feedback loops and control methods will now be described to illustrate potential functionality of the engine 100.

The controller is configured to receive a signal indicative of a temperature of the recuperator 160 and to control operation of the engine 100 based on the received signal. The controller may be controlling operation of the engine 100 to be in the engine braking mode. In the engine braking mode, the controller may control operation of the engine 100 to keep the temperature of the recuperator 160 within a selected range. For example, the controller may be configured to keep the recuperator temperature at above a minimum threshold temperature and/or to keep the recuperator temperature below a maximum threshold temperature. The controller (and sensors) may be configured to provide a dynamic feedback loop for operation of the engine 100. In other words, the controller may be configured to keep receiving signals indicative of recuperator temperature and to keep controlling operation of the engine 100 accordingly to keep the recuperator temperature within its selected range.

In the event that the controller receives a signal indicating that the recuperator temperature is outside the selected range when operating in the engine braking mode, the controller is configured to control operation of the engine 100 to regulate flow of working fluid through the recuperator 160. For this, the controller may be configured to control operation of a recuperator bypass passage. The controller may control operation to adjust the proportion of hotter and/or cooler fluid passing through the recuperator bypass passage based on the indication of the recuperator temperature. For example, the controller may control operation of the engine to balance the heating effect to the recuperator 160 provided by hotter fluid with the cooling effect to the recuperator 160 provided by cooler fluid.

In the event that the recuperator temperature is too low, the controller is configured to increase the amount of hotter fluid passing through the recuperator 160 and/or to decrease the amount of cooler fluid passing through the recuperator 160. For example, the controller may be configured to act so that operation of the engine provides a greater heating effect to the recuperator 160 and/or a smaller cooling effect to the recuperator 160. Where relevant, the controller may control operation of the engine 100 to increase the amount of hotter exhaust fluid passing through the low-pressure recuperator heat exchange passage 162 or to decrease the amount of cooler compressed fluid passing through the high-pressure recuperator heat exchange passage 161 to increase the recuperator temperature. For this, the controller is configured to selectively use the low-pressure recuperator bypass passage 164 less and/or to use the high-pressure recuperator bypass passage 163 more.

The controller may be configured to vary the proportion of fluid passing through the recuperator bypass passage based on a difference between the indication of recuperator temperature and the threshold temperature (e.g. so that recuperator bypass passages are used more/less when the temperature needs to change more/less). For example, the controller may control operation of the engine 100 so that at least some fluid passes through a recuperator bypass passage when operating in the engine braking mode. The low-pressure bypass passage may be used in the event that the recuperator temperature gets too low, and/or the high-pressure recuperator bypass passage 163 may be used in the event that the recuperator temperature gets too high.

In the event that the controller receives a signal indicating that the recuperator temperature is outside the selected range when operating in the engine braking mode, the controller is configured to control operation of the engine 100 to regulate the amount of hot exhausted fluid from the combustion cylinder 120 which is drawn back into the combustion cylinder 120 for further compression (and heating). For this, the controller may be configured to control the opening and/or closing positions of the outlet valve 126 of the combustion cylinder 120. The control may select the opening and/or closing positions for the outlet valve 126 of the combustion cylinder 120 to adjust the amount of hot exhaust fluid drawn back into the combustion cylinder 120 for further compression therein. For example, the controller may control the opening and/or closing positions based on the indicated temperature. In the event that the recuperator temperature is too low, the outlet valve 126 of the combustion cylinder 120 may be opened for a longer period of time as the combustion piston 122 moves towards its BDC position (from its TDC position). For example, the controller may be configured to select the position to be closer to BDC than TDC to increase the temperature of the recuperator 160 (and vice-versa). The controller may regulate the opening and/or closing positions dynamically in dependence on the recuperator temperature (e.g. so that the positions change by an amount selected based on the difference in temperature between the recuperator temperature and the threshold temperature).

In the event that the controller receives a signal indicating that the recuperator temperature is outside the selected range when operating in the engine braking mode, the controller is configured to control operation of the engine 100 to regulate flow of working fluid to drive the turbine 152. For this, the controller may be configured to control operation of the turbine bypass passage 154. The controller may control operation to adjust the proportion of fluid passing through the turbine bypass passage 154 based on the indication of the recuperator temperature. In the event that the recuperator temperature is too low, the controller is configured to control operation of the turbine bypass passage 154 to increase heating effect. The controller is configured to decrease the amount of exhausted fluid flowing through the turbine bypass passage 154 (e.g. to increase fluid flow past the turbine 152). As such, the turbine 152 will drive more work of the compressor 151, leading to more working fluid being compressed in the compression cylinder 110, and a greater heating effect being provided.

The controller may be configured to vary the proportion of exhaust fluid passing through the turbine bypass passage 154 based on a difference between the indication of recuperator temperature and the threshold temperature (e.g. so that the turbine bypass passage 154 is used more/less when the temperature needs to change more/less). For example, the controller may control operation of the engine 100 so that at least some fluid passes through the turbine bypass passage 154 when operating in the engine braking mode.

In the event that the controller receives a signal indicating that the recuperator temperature is outside the selected range when operating in the engine braking mode, the controller may be configured to control operation of the engine 100 to regulate an amount of coolant supplied to the engine 100, and/or to regulate an amount of working fluid passing through the engine 100.

For this, the controller may be configured to control operation of the coolant system (e.g. to increase or decrease the amount of coolant supplied to decrease or increase temperature respectively). The controller may be configured to control the amount of working fluid stored in the compressed gas storage unit to control the amount of working fluid passing through the engine 100 (e.g. to store more compressed fluid to increase temperature).

In the above exemplary feedback loops, the controller is configured to receive an indication of a temperature of the engine 100. For example, this may be a temperature of the recuperator 160.

The controller is configured to regulate operation of the engine 100 to control this temperature (e.g. as per the examples described above). For example, the controller may control operation of the engine 100 so that the recuperator temperature remains within a threshold range. This control of the recuperator 160 may be to retain the recuperator 160 at a temperature selected based on desired operating conditions for the temperature of the recuperator 160 in the active mode. For example, the controller may regulate the recuperator temperature to be above a threshold value to keep the recuperator 160 sufficiently warm to provide efficient operating conditions for the engine 100 when the engine 100 returns to operating in its active mode.

Additionally, or alternatively, the controller may be configured to control operation of the engine 100 to regulate a temperature of the engine 100 for different reasons. For example, operation of the engine 100 may be controlled to provide maintenance of the engine 100 when operating in the engine braking mode. A catalyst may be provided as part of the recuperator 160 (e.g. inside the recuperator 160). In the engine braking mode, the controller may control operation to provide a catalytic reaction in the recuperator 160 (e.g. a reaction to help the performance of the catalyst during operation of the engine). For example, the temperature may be regulated to be in a threshold range for providing this reaction (e.g. the temperature of the recuperator 160 may be controlled to exceed a threshold temperature for providing a catalytic reaction). For example, such operation may act to burn any unwanted substances off a catalytic coating of the recuperator 160. During operation of the engine, a particulate build up on the catalytic coating may occur. For example by heating up the temperature of the recuperator (e.g. during the engine braking mode), this may act to provide de-sooting of the engine 100 (e.g. removing unwanted particulate matter from the catalytic coating to improve future engine performance when back in the active mode). The controller may be able to control operation of the engine 100 in the active mode to provide such maintenance of the recuperator 160 (e.g. for de-sooting/providing a catalytic event). For this, the controller may be configured to control injection of fuel to be delayed, e.g. so that some combustion occurs at a later position in the engine cycle, thereby leading to hotter fluid being exhausted from the combustion cylinder 120.

Additionally, or alternatively, to controlling operation of the engine 100 in the engine braking mode to provide a selected temperature for the recuperator 160, the controller may be configured to control operation of the engine 100 to provide a desired amount of engine braking. For example, the controller may be configured to receive a signal indicative of a pressure of working fluid and/or of an amount of engine braking being provided. The controller may be configured to control operation of the engine 100 based on this received signal to provide more or less engine braking accordingly. It is to be appreciated in the context of the present disclosure that operation may be controlled using the features described above, but to provide variable engine braking. For example, the controller may adjust the position at which the inlet and/or outlet valves of the combustion cylinder 120 open and/or close to control the amount of compression work being performed in the combustion cylinder 120 (e.g. to increase compression work to provide more engine braking).

Additionally, or alternatively, the engine 100 may be controlled to extract and stored compressed gas in the compressed gas storage unit when operating in the engine braking mode. The amount of compressed gas to be extracted and/or stored may be selected depending on operating conditions of the engine 100 and/or how full the storage unit(s) are. For example, in the event that the controller switches to operating in the engine braking mode, the controller may control operation of the one or more gas collection points to start directing some compressed working fluid to a gas storage unit of the engine 100. The controller may keep extracting some gas until the active mode is activated, or the gas storage unit becomes full, and/or if a different amount of engine braking and/or heating is required for the engine 100 when in the engine braking mode.

The controller may be configured to selectively release compressed gas from the gas storage unit during operation of the engine 100 in the active mode. Compressed gas may be released to support the flow of working fluid through the engine 100 (e.g. to supplement the engine 100).

For example, the controller may be configured to control the gas storage unit to provide compressed gas to increase power output of the engine 100 (e.g. in response to a demand signal for the engine indicating additional output is wanted, such as in response to switching back to the active mode and/or in response to acceleration of the engine 100). The engine 100 may be configured so that compressed gas may be released from the gas storage unit to drive the turbine 152 of the turbocharger 150. Additionally, or alternatively, compressed fluid may be released from the gas storage unit towards the combustion cylinder 120.

It will be appreciated in the context of the above disclosure that features described in relation to FIG. 2 are optional, and not all of the features shown need to be provided together in combination. For example, engines of the present disclosure may be provided with some, but not all, of the features shown in FIG. 2. For example, only one recuperator bypass passage may be used. As another example the turbo charger may not be provided, or it may not include a turbine bypass passage 154. It is also to be appreciated that where engines are provided with multiple components described above, operation of any or all of the different components may be controlled together (e.g. so that the operation of one or more of the components may be controlled based on operation of one or more other components, e.g. to increase temperature of the recuperator 160, the high-pressure recuperator bypass passage 163 may be used more in combination with delaying the outlet valve 126 closure position for the combustion cylinder 120). The controller may be configured to control operation of the engine based on one or more signals indicative of engine parameters. It is to be appreciated that any suitable indication of engine parameter may be used. For example, where the indication is of a recuperator temperature, that may be obtained using a temperature sensor coupled to the recuperator 160, but it could also be obtained using other means, such as based on an indication of a temperature change for working fluid flowing through the recuperator 160/a temperature of fluid after the recuperator 160 etc.

It will also be appreciated that more than one of each cylinder may be provided. For example, a split cycle engine may comprise multiple compression and/or combustion cylinders. The controller may be configured to control operation of all of the different cylinders together. For example, in the active mode, operation of the combustion cylinders may be staggered so that each combustion piston is driven towards its respective BDC position at a time offset from other combustion pistons. Likewise, when controlling outlet valve 126 timings for the combustion cylinders to swap into the engine braking mode, these timings may be offset from each other (e.g. so that each combustion cylinder is providing engine braking at a different time to other combustion cylinders). The number of compression and combustion cylinders need not be the same either. For example, the crossover passage 130 may have a plurality of inlets (from respective compression cylinders) and a plurality of outlets (to respective combustion cylinders).

Each may have a respective valve to control flow of fluid therethrough. The number of inlets and outlets could be different, e.g. so that there may be 5 compression cylinders and 3 combustion cylinders.

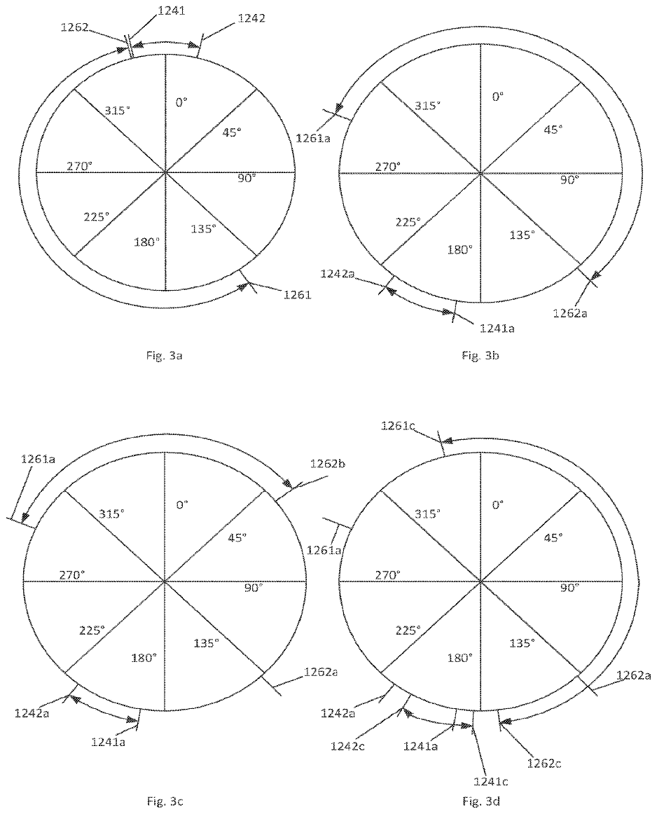

FIGS. 3a to 3d show exemplary timing diagrams for illustrating exemplary modes of operation of the engine 100. These timing diagrams show the cycle of the combustion piston 122 from 0° (its top dead centre position) through to 180+θ (its bottom dead centre position) and back again to 360°/0°. The lines extending radially outward from the circle illustrate opening and closing times for the inlet valve 124 and the outlet valve 126. References 1241 and 1261 are used to generally denote opening of inlet and outlet valves respectively, and references 1242 and 1262 are used to generally denote closing of the inlet and outlet valves respectively. Arrows are shown linking the opening and closing time for each valve to show when the valve will be open (i.e. when fluid may flow through that valve).

FIG. 3a illustrates valve timings for operation in the active mode. The inlet valve 124 is opened at 1241, which is shortly before TDC (e.g. somewhere between 0° and 20° prior to TDC). The inlet valve 124 is then closed at 1242, which is shortly after TDC (e.g. somewhere between 0° and 20° after TDC). The outlet valve 126 is then opened at 1261, which is between BDC and TDC, typically at a position closer to BDC than TDC. In FIG. 3a, this is shown at approximately 140° to 150+θ. The outlet valve 126 then remains open for a longer time than the inlet valve 124.

The outlet valve 126 then shuts shortly prior to the inlet valve 124 opening. In FIG. 3a, the outlet valve closes at 1262, which is just before the inlet valve 124 opens at 1241 (e.g. at 10° to 40° before TDC). As such, compressed fluid will flow into the combustion cylinder 120 between 1241 and 1242. Combustion will then occur causing expansion of the working fluid and driving of the combustion piston 122 towards its TDC position. The exhaust valve 126 is then open between 1261 and 1262. Movement of the combustion piston 122 from TDC towards BDC will act to push out combusted fluid which remains in the combustion cylinder 120 (e.g. so that the majority of the combusted fluid is exhausted from the combustion cylinder 120 before the cycle repeats and new working fluid is drawn into the combustion cylinder 120).

FIG. 3b illustrates a first set of exemplary valve timings for operation in the engine braking mode. In FIG. 3b, the opening/closing positions change, but their fixed offset remains the same.

For example, the opening and closing of each valve may be actuated by rotation of a cam shaft (e.g. so that opening/closing occurs at a selected phase of rotation). As such, the combustion piston 122 will move through the same crank degrees of rotation between the valves opening and closing. However, the position at which the opening and closing occurs will change.

In FIG. 3b, the inlet valve 124 is opened at 1241a, which is shortly after BDC (e.g. somewhere between 0° and 40° after BDC). The inlet valve 124 is then closed at 1242a, which is between TDC and BDC, typically at a position closer to BDC than TDC. In FIG. 3a, this show at somewhere between 20° and 40+θ after TDC). The outlet valve 126 is then opened at 1261a, which is between TDC and BDC, typically at a position closer to TDC than BDC. In FIG. 3b, this is shown at approximately 50° to 70° before TDC. The outlet valve 126 then remains open for a longer time than the inlet valve 124 (the opening durations are the same as for the active mode, but their locations are different). The outlet valve 126 then shuts at 1262a, which is between TDC and BDC (e.g. at 20° to 60° before TDC). As such, compressed fluid will flow into the combustion cylinder 120 between 1241a and 1242a. Movement of the combustion piston 122 towards TDC will provide further compression of this working fluid. The exhaust valve 126 is then open between 1261a and 1262a. Movement of the combustion piston 122 towards TDC will act to push some of the further compressed fluid out of the combustion cylinder 120 through the outlet valve 126. Then, with the outlet valve 126 still open, movement of the combustion piston 122 back towards BDC after it has passed through TDC, will act to draw some of the further compressed fluid which was exhausted from the combustion cylinder 120 back into the combustion cylinder 120. Some of this further compressed fluid which is drawn back in may then be further compressed in the combustion cylinder 120 again.

FIGS. 3c and 3d show slightly different opening/closing positions to that of FIG. 3b. For example, the valves may be independently opened and closed, and the timing of this opening/closing may be varied freely (e.g. they do not need a fixed offset). For example, a hydraulic/pneumatic actuated valve may be used. In both FIGS. 3c and 3d, the valve opening and closing positions from FIG. 3b (1241a, 1242a, 1261a, 1262a) are shown to illustrate any differences in opening/closing positions.

In FIG. 3c, the only difference is that the outlet valve closes at 1262b (rather than at 1262a).

Position 1262b occurs closer to the opening position 1261a. This closing position is therefore also closer to TDC than that of FIG. 3b. For example, the controller may control operation of the engine to switch from the position of FIG. 3b to the position of FIG. 3c to reduce the amount of further compressed fluid exhausted from the combustion cylinder which is drawn back into the combustion cylinder. This may be done to regulate the temperature of the recuperator (e.g. because as more such fluid is drawn back in, the temperature of exhausted fluid will increase, as it will be starting its further compression a hotter temperature). For example, the controller may be configured to select the closing position to regulate the temperature of the recuperator.

In FIG. 3d, all four positions have changed. The inlet valve opens at 1241c and closes at 1242c, and both of these are closer to BDC than their respective positions for FIG. 3b (1241a and 1242a). The outlet valve opens at 1261c and closes at 1262c, and both of these positions occur later than their FIG. 3b counterparts (1261a and 1262a). For example, the controller may select such positions to increase the amount of compression provided in the combustion cylinder 120 (e.g. to maximise the difference in position between inlet closing 1242c and outlet opening 1261c). For example, the controller may select such positions to increase the temperature of the engine (e.g. recuperator), by drawing more hot exhausted fluid back into the combustion cylinder 120 (e.g. to maximise the difference in position between TDC, with the outlet valve open, and the outlet valve closing 1262c).

It will be appreciated that the relevant positions shown in FIGS. 3a and 3d are exemplary to illustrate the underlying concept, but are not to be considered limiting. The precise opening and closing positions may vary, and their exact positions may be selected based on desired operating conditions for the engine.

It will be appreciated that the description of engines herein has been with reference to engines in which there is reciprocating movement of a piston within a cylinder between TDC and BDC positions. In these examples, the combustion piston effectively moves in one dimension (forwards and backwards). However, it is to be appreciated that this should not be limited. For example, a Wankel engine may be provided in which the piston moves in a rotational manner between BDC and TDC positions.

It will be appreciated from the discussion above that the examples shown in the figures are merely exemplary, and include features which may be generalised, removed or replaced as described herein and as set out in the claims. With reference to the drawings in general, it will be appreciated that schematic functional block diagrams are used to indicate functionality of systems and apparatus described herein. As will be appreciated by the skilled reader in the context of the present disclosure, each of the examples described herein may be implemented in a variety of different ways. Any feature of any aspects of the disclosure may be combined with any of the other aspects of the disclosure. For example, method aspects may be combined with apparatus aspects, and features described with reference to the operation of particular elements of apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Furthermore, equivalents and modifications not described above may also be employed without departing from the invention.

Certain features of the methods described herein may be implemented in hardware, and one or more functions of the apparatus may be implemented in method steps. It will also be appreciated in the context of the present disclosure that the methods described herein need not be performed in the order in which they are described. Accordingly, aspects of the disclosure which are described with reference to products or apparatus are also intended to be implemented as methods and vice versa. Aspects of the control methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates. For example, any controller described herein may be provided by any control apparatus such as a general purpose processor configured with a computer program product configured to program the processor to operate according to any one of the methods described herein. In addition, the functionality of the controller may be provided by an application specific integrated circuit, ASIC, or by a field programmable gate array, FPGA, or by a configuration of logic gates, or by any other control apparatus.

In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein.

Other examples and variations of the disclosure will be apparent to the skilled addressee in the context of the present disclosure.

1. A split cycle internal combustion engine comprising:
a compression cylinder accommodating a compression piston configured to provide compressed working fluid;
a combustion cylinder accommodating a combustion piston, wherein the combustion cylinder is coupled to the compression cylinder to receive compressed working fluid therefrom, and wherein the combustion cylinder comprises: (i) an inlet valve configured to control intake of compressed working fluid into the combustion cylinder, and (ii) an outlet valve configured to control exhausting of fluid from the combustion cylinder;
a recuperator positioned between and coupled to the compression cylinder and combustion cylinder; and
a controller configured to change the position during the engine cycle at which the inlet and/or outlet valves open to switch operation of the engine between an active mode and an engine braking mode, wherein the controller is configured to control at least one of:
the inlet valve to open at a position which is closer to a bottom dead centre, BDC, position when operating in the engine braking mode than when operating in the active mode; and
the outlet valve to open at a position which is closer to a top dead centre, TDC, position when operating in the engine braking mode than when operating in the active mode,
wherein the recuperator is arranged to provide a heat exchange between fluid which has been exhausted from the combustion cylinder and compressed working fluid travelling from the compression cylinder to the combustion cylinder, and
wherein the controller is configured to receive a signal that indicates a temperature of the recuperator and to control operation at least related to a proportional flow of the compressed working fluid of the engine through the recuperator based on the received signal so as to keep the temperature of the recuperator within a selected range.

2. The split cycle internal combustion engine of claim 1, wherein the controller is configured to control the position at which the inlet valve opens and/or closes in the engine braking mode so that working fluid is being further compressed in the combustion cylinder for a majority of the movement of the combustion piston from its BDC position to its TDC position.

3. The split cycle internal combustion engine of claim 1, wherein the controller is configured to control the position at which the outlet valve opens and/or closes in the engine braking mode so that further compressed fluid is exhausted from the combustion cylinder.

4. The split cycle internal combustion engine of claim 3, wherein the controller is configured to control the outlet valve to open at a position before the TDC position in the engine braking mode.

5. The split cycle internal combustion engine of claim 1, wherein the controller is configured to change the position during the engine cycle at which the inlet and/or outlet valves close when switching operation between the active mode and the engine braking mode.

6. The split cycle internal combustion engine of claim 1, wherein the engine further comprises a fuel reservoir and is configured to inject fuel for combustion into the combustion cylinder; and
wherein the controller is configured to control injecting of fuel so that no fuel is injected when operating in the engine braking mode.

7. The split cycle internal combustion engine of claim 1, wherein the controller is configured to receive a demand signal for demand from the engine; and
wherein the controller is configured to control operation of the engine to be in either the active mode or the engine braking mode based on the demand signal.

8. The split cycle internal combustion engine of claim 7, wherein the controller is configured to control opening and/or closing positions for at least one of the inlet valve and the outlet valve based on the demand signal.

9. The split cycle internal combustion engine of claim 1, wherein the engine comprises a recuperator bypass passage.

10. The split cycle internal combustion engine of claim 9, wherein the controller is configured to receive a signal indicative of a temperature of the recuperator and to control operation of the recuperator bypass passage based on said received signal.

11. The split cycle internal combustion engine of claim 9, wherein the recuperator bypass passage comprises at least one of:
a high-pressure bypass passage arranged to provide a flow path for compressed fluid from the compression cylinder to the combustion cylinder which avoids the recuperator; and
a low-pressure bypass passage arranged to provide a flow path for fluid exhausted from the combustion cylinder which avoids the recuperator.

12. The split cycle internal combustion engine of claim 11, wherein:
the controller is configured to control operation of the engine so that fluid flows through the high-pressure bypass passage in the event that a temperature associated with the recuperator drops below a threshold value; and/or
the controller is configured to control operation of the engine so that fluid flows through the low-pressure bypass passage in the event that a temperature and/or pressure associated with working fluid exceeds a threshold value.

13. The split cycle internal combustion engine of claim 1, wherein the engine further comprises a turbocharger having: (i) a turbine arranged to be driven by fluid exhausted from the combustion cylinder, and (ii) a compressor configured to force additional compressed fluid into the compression cylinder.

14. The split cycle internal combustion engine of claim 13, wherein the engine further comprises a turbine bypass passage arranged to provide a flow path for fluid exhausted from the combustion cylinder which avoids the turbine; and
wherein the controller is configured to control operation of the turbine bypass passage to provide a selected amount of compressed working fluid be provided to the compression cylinder.

15. The split cycle internal combustion engine of claim 1, wherein the engine further comprises a compressed gas storage unit arranged to receive gas compressed by the engine.

16. The split cycle internal combustion engine of claim 15, wherein the compressed gas storage unit comprises one or more storage units arranged to receive compressed gas which has been compressed in the compression cylinder and/or further compressed gas which has been further compressed in the combustion cylinder.

17. The split cycle internal combustion engine of claim 1, further comprising one or more phase change materials configured to store excess energy from the engine when operating in the engine braking mode.

18. The split cycle internal combustion engine of claim 9, wherein the controller is configured to control operation of the recuperator bypass passage so as to adjust an amount of fluid passing through the recuperator bypass passage based on the received signal so as to keep the temperature of the recuperator within the selected range.

19. The split cycle internal combustion engine of claim 1, wherein the controller is configured to control operation of the opening and closing times of the outlet valve of the combustion chamber based on the received signal so as to keep the temperature of the recuperator within the selected range.

20. A method of operating a split cycle internal combustion engine, wherein the split cycle internal combustion engine comprises:
a compression cylinder accommodating a compression piston configured to provide compressed working fluid; and
(ii) a combustion cylinder accommodating a combustion piston, wherein the combustion cylinder is coupled to the compression cylinder to receive compressed working fluid therefrom, and wherein the combustion cylinder comprises: (i) an inlet valve configured to control intake of compressed working fluid into the combustion cylinder, and (ii) an outlet valve configured to control exhausting of fluid from the combustion cylinder;
a recuperator positioned between and coupled to the compression cylinder and combustion cylinder; and
wherein the method comprises changing the position during the engine cycle at which the inlet and/or outlet valves open to switch operation of the engine between an active mode and an engine braking mode, and controlling at least one of:
the inlet valve to open at a position which is closer to a bottom dead centre, BDC, position when operating in the engine braking mode than when operating in the active mode; and
the outlet valve to open at a position which is closer to a top dead centre, TDC, position when operating in the engine braking mode than when operating in the active mode,
wherein the recuperator is arranged to provide a heat exchange between fluid which has been exhausted from the combustion cylinder and compressed working fluid travelling from the compression cylinder to the combustion cylinder, and
wherein the controller is configured to receive a signal that indicates a temperature of the recuperator and to control operation at least related to a proportional flow of the compressed working fluid of the engine through the recuperator based on the received signal so as to keep the temperature of the recuperator within a selected range.

21. A computer program product comprising computer program instructions configured to program a processor to control operation of a split cycle internal combustion engine to perform the method of claim 20.
